(19) United States
(12) Patent Application Publication
(10) Pub. No.: US 2009/0006702 A1
(43) Pub. Date: Jan. 1, 2009

(54) SHARING UNIVERSAL SERIAL BUS ISOCHRONOUS BANDWIDTH BETWEEN MULTIPLE VIRTUAL MACHINES

(76) Inventors: Nitin Sarangdhar, Portland, OR (US); Balaji Vembu, Folsom, CA (US)

Correspondence Address: INTEL CORPORATION;c/o INTELLEVATE, LLC, P.O. BOX 52050, MINNEAPOLIS, MN, 55402, US

(21) Appl. No.: 11/768,696

(22) Filed: Jun. 26, 2007

(51) Int. Cl. G06F 13/14

(52) U.S. Cl. 710/305

(57) ABSTRACT

A method and computer readable medium are disclosed. In one embodiment, the method includes enumerating multiple Universal Serial Bus (USB) devices on a computer platform running a multiple virtual machines (VMs). The method also includes assigning each of the USB devices to a VM, wherein each USB device may be assigned to a different VM. The method also includes making each USB device visible only to the VM it is assigned to. The method also includes limiting the bandwidth each of the VMs can schedule its assigned devices within a USB data transfer frame. This will allow all of the VMs to have access to the bandwidth of the frame by avoiding the problem of over-subscription when the schedule is merged.

### FIELD OF THE INVENTION

The invention relates to the Universal Serial Bus (USB) and computer virtualization. More specifically, the invention relates to sharing USB isochronous bandwidth between multiple virtual machines.

### BACKGROUND OF THE INVENTION

The Universal Serial Bus (USB) architecture uses a software managed schedule for managing data transfers from memory-to-device and device-to-memory. The schedule for data transfers is built around a time-window of a frame. A frame is the basic unit of scheduling isochronous and asynchronous data transfers across a USB inter-connect. The USB driver is responsible for ensuring that it builds frame schedules such that the transfers within a frame can be completed within the allotted time.

This frame-based scheduling mechanism works well in an environment where the software building the frame schedule is aware of all the USB devices in the computer platform and their requirements. However, in a virtualized environment with multiple partitions, where multiple virtual machines may be running on the computer platform without knowledge of the other virtual machines, there maybe multiple USB stacks (i.e. frame lists/schedules) running on the computer platform (one per VM) that are unaware of each other. This is because, in a virtualized environment, each VM creates a schedule agnostic (unaware) of the other VMs.

### BRIEF DESCRIPTION OF THE DRAWINGS

The present invention is illustrated by way of example and is not limited by the figures, in which like references indicate similar elements, and in which:

FIG. 1 describes one embodiment of a computer platform that utilizes a USB Policy Manager to facilitate sharing of Universal Serial Bus (USB) isochronous traffic between multiple virtual machines (VMs).

FIG. 2 describes one embodiment of a configuration of multiple virtual machines that are sharing USB bandwidth.

FIG. 3 is a flow diagram of one embodiment of a process to share USB isochronous bandwidth among multiple virtual machines.

### DETAILED DESCRIPTION OF THE INVENTION

Embodiments of a method and computer readable medium to share USB isochronous bandwidth among multiple virtual machines on a computer platform are described. In the following description, numerous specific details are set forth. However, it is understood that embodiments may be practiced without these specific details. In other instances, well-known elements, specifications, and protocols have not been discussed in detail in order to avoid obscuring the present invention.

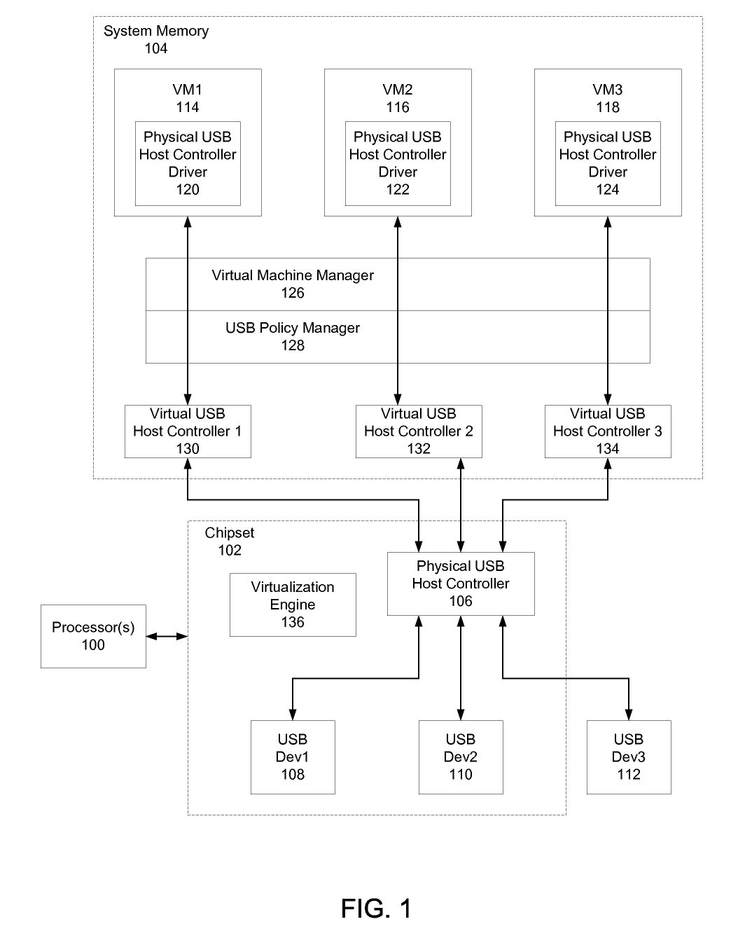

FIG. 1 describes one embodiment of a computer platform that utilizes a USB Policy Manager to facilitate sharing of Universal Serial Bus (USB) isochronous traffic between multiple virtual machines (VMs). The computer platform may include one or more processor(s) 100. Each processor may include one or more processor cores. Additionally, in some multiprocessor embodiments of the computer platform, multiple processor dies are coupled together, each including one or more cores per die. In different embodiments, the one or more processors may be any type of central processing units (CPUs) designed for use in any form of personal computer, handheld device, server, workstation, or other computing device available today.

The computer platform may also include a chipset 102 to facilitate the transmission of information from one location in the computer platform to another (e.g. from the processor(s) 100 to system memory 104 and vice versa). In many embodiments, the chipset 102 includes a memory controller to control access to system memory 104. The memory controller is not shown so as to not obscure the invention. In other embodiments, the memory controller is integrated into the processor (100) Silicon die. One portion of the chipset is the south bridge (i.e. I/O controller hub). The south bridge may contain one or more I/O controllers, where each controller controls an I/O interconnect in the computer platform. In many embodiments, one of the I/O interconnects in the computer platform is a USB interconnect. The presence of a USB interconnect requires at least one physical USB Host Controller, such as controller 106, present in the computer platform.

One or more USB devices may be coupled to the physical USB host controller 106. In many embodiments, some of the USB devices are internal to the south bridge of the chipset, such as USB device 1 (108) and USB device 2 (110). Additionally, in many embodiments, some of the USB devices are external to the south bridge of the chipset, such as USB device 3 (112). The physical USB host controller 106 has a number of ports, where each port can accommodate one USB device.

As mentioned above, the computer platform also includes a system memory 104. System memory 104 may be comprised of a specific type of dynamic random access memory (DRAM), such as, for example, double data rate (DDR) synchronous DRAM. In many embodiments, system memory 104 stores information related to the operation of the computer platform, including one or more operating systems (not shown), a virtual machine manager (VMM) 126, and one or more VMs, (VM1 114, VM2 116, and VM3 118 in the particular example in FIG. 1). The VMM 126 schedules which VMs have access to the computing (CPU) and platform resources such as a USB device. The VMs provide a way to partition the computer platform. Thus, if a VM operating in the computer platform wants to communicate with the physical USB host controller 106 in the chipset 102, each VM may be required to have its own copy of the physical USB host controller driver. Therefore, drivers 120, 122, and 124 reside on each of VM 1114, VM2 116, and VM3 118, respectively.

In a virtualized environment with multiple partitions, each VM, running on top of the VMM, operates within its own partition. In this environment, there may be a USB stack running in each VM without knowledge of any of the other USB stacks in the computer platform. A USB stack includes the operating environment of the USB interconnect subsystem, such as a USB frame list.

Furthermore, in some embodiments, each VM may own and access one or more USB devices. This requires each VM to have its own USB hardware and software stack (the hardware and software stack include the USB host controller, USB host controller driver, and any USB devices coupled downstream of the USB host controller). It is impractical to provide a physical USB host controller for each VM.

Thus, in many embodiments, a virtualization engine 136 is integrated in the chipset 102. The virtualization engine 136 allows the separation of the USB devices among multiple virtual platforms, each having a VM. The virtualization engine 136 does this by virtualizing the physical USB host controller 106 into a virtual USB host controller for each virtual platform. Each virtual USB host controller maps to the physical USB host controller. Each virtual platform includes its own partitioned memory space and its own operating system. The processor can switch execution between these multiple virtual platforms by utilizing the VMM 126. The VMM 126 can then assign virtual host controller to different VMs. The virtualization engine 126 includes logic to effectively allow the rest of the computer platform (including the I/O devices) to support multiple virtual machines.

In the illustrated embodiment, the virtualization engine 136 will expose a virtual USB host controller for each VM (i.e. USB host controller 1, 2, and 3 (130, 132, and 134 respectively)). A virtual USB host controller is a virtual representation of the physical USB host controller 106 that is specific to a single VM. Each virtual host controller includes a copy (with data specific to the VM it is assigned to) of the port registers and any other data stored within the physical USB host controller 106. In a partitioned environment each VM assumes it interfaces directly with the physical USB host controller 106 and has 100% of the USB stack bandwidth to itself. In actuality, each VM interfaces with a virtual USB host controller exposed by the virtualization engine 136, and each virtual USB host controller is a representation of the physical USB host controller 106, specific to each VM.

In many embodiments, a USB policy manager 128 is stored within system memory 104 and operates within the processor 100. In other embodiments, the USB policy manager 128 operates within firmware stored within the computer platform. In yet other embodiments, the USB policy manager 128 operates within the memory space allocated to the host or the VMM 126. All USB devices are first assigned to the USB policy manager 128 when they are plugged into the computer platform. The USB policy manager 128 is responsible for device pre-processing: device enumeration and then device assignment to the appropriate VM based on a configured device assignment policy that has been pre-stored in the computer platform, or based on user direction.

The USB policy manager 128 controls visibility of devices by causing a virtual USB host controller to only reflect a device that is assigned to the VM the virtual USB host controller is assigned to. In FIG. 1, attaching USB device 1 108 is reflected only in virtual USB host controller 1's (130) port registers, attaching USB device 2 110 is reflected only in virtual USB host controller 2's (132) port registers, and so on.

When a device is transferred from the USB policy manager 128 to a guest VM, the guest VM receiving the device will perform its own enumeration. The USB policy manager 128 ensures that a USB device is only visible to the VM that it is allocated to. Thus, if USB device 1 108 is assigned to VM1 114, then USB Device 1 108 cannot be seen VM2 116 or VM3 118.

The physical USB host controller driver in each VM (120, 122, and 124) builds a schedule (a frame list) for the transfer of data between a given VM and a device reflected in the virtual USB host controller's port registers. In some embodiments, to service all the USB devices, the physical USB host controller that underlies the virtual USB host controllers, executes a merge schedule comprising all the VMs' schedules. In other embodiments, the virtualization engine merges the schedules and provides a master schedule for the physical USB host controller 106 to traverse. The schedule merge must follow USB protocol, which requires all scheduled data transfers in VM schedules for a specific frame to be executed in that frame even after the merge. for each frame every USB device, into each frame of the merged schedule. The specifics of merging the schedules is beyond the scope of this invention.

In some embodiments, the logic associated with the USB policy manager 128 discussed above may be integrated into the virtualization engine 136 instead of in a separate USB policy manager 128 device.

As mentioned above, because each USB stack is completely unaware that it is sharing the USB bandwidth with other devices assigned to other VMs, the stack in any given VM may attempt to use the entire bandwidth available per frame for the one or more devices it is assigned. For example, if there are three VMs and each VM uses 50% of a frame, then the merged bandwidth (150%) exceeds a frame's maximum bandwidth.

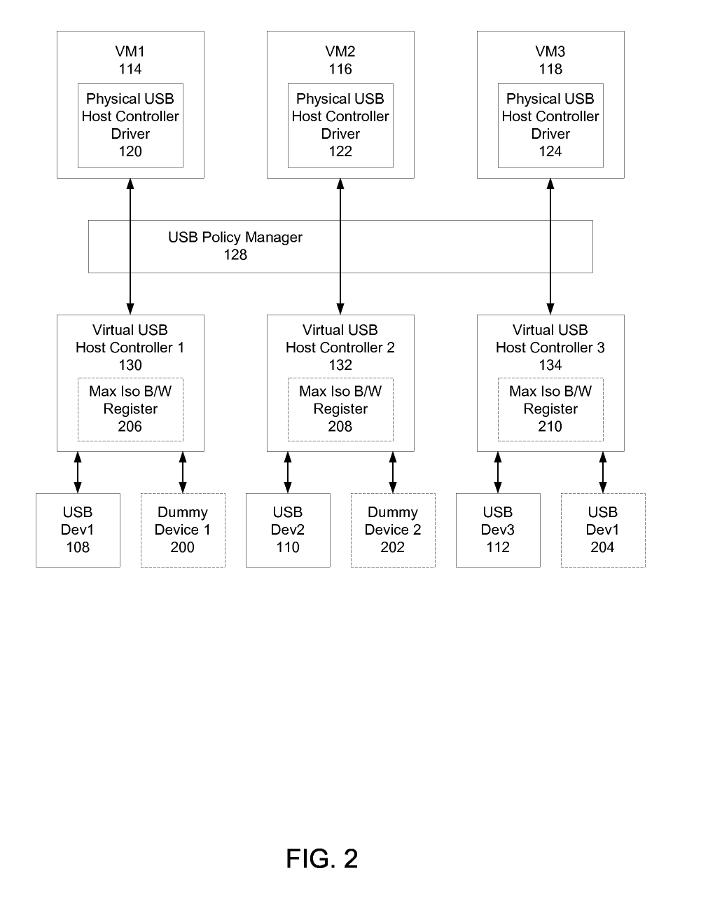

Thus, FIG. 2 describes one embodiment of a configuration of multiple virtual machines to sharing USB bandwidth. Some of the relevant components from FIG. 1 are included in FIG. 2 as well. In the example embodiments as discussed in FIG. 1, there are three VM's in the computer platform (VM1 114, VM2 116, and VM3 118). Additionally, three USB devices (USB device 1 108, USB device 2 110, and USB device 3 112) are coupled to the physical USB host controller (not shown in FIG. 2). Three virtual USB host controllers (130, 132, and 134) are exposed by the virtualization engine 136. In the embodiment shown in FIG. 2, VM1 114 communicates with USB device 1 108 through virtual USB host controller 1 130, VM2 116 communicates with USB device 2 110 through virtual USB host controller 2 132, and VM3 118 communicates with USB device 3 112 through virtual USB host controller 3 134. Furthermore, VM1 114 is not aware of USB devices 2 and 3 (110 and 112), VM2 116 is not aware of USB devices 1 and 3 (108 and 112), and VM3 118 is not aware of USB devices 1 and 2 (108 and 1 10). Thus, in this example, without intervention, each VM may attempt to utilize 100% of the USB interface bandwidth itself.

In many embodiments, the USB policy manager 128 or virtualization engine 136, inserts one or more dummy devices in the computer platform to be assigned to each VM. The dummy devices may be inserted at particular ports in each virtual USB host controller. For example, dummy device 1 200 is inserted in a port of virtual USB host controller 1 130, dummy device 2 202 is inserted in a port of virtual USB host controller 2 132, and dummy device 3 204 is inserted in a port of virtual USB host controller 3 134. A dummy device is just a representation of a device, specifically, the USB policy manager 128 just manipulates registers and data fields for a specific port within a virtual USB host controller that reflects a device attached to the port. In reality, no device is present, but the modification of the port status and port registers will lead the VM to believe a device has been attached. By performing handshake with this dummy device the VM will be able to determine how much USB bandwidth is consumed by the dummy device. This value tells the VM how much bandwidth in the USB stack, per frame, the device attached to the port will require for operation.

In some embodiments, one dummy device is inserted per VM. In this scenario, the dummy device will report the total bandwidth that all the other VMs (and their real devices) require per frame. In other words, dummy device 1 200 required bandwidth would be equal to the bandwidth required for all devices attached to VM2 116 plus the bandwidth required for all devices attached to VM3 118 (because only one device is attached per VM in this example, this would be equal to USB device 2 110 and USB device 3 112 required bandwidth).

In other embodiments, one dummy device is inserted for each of the other VMs. In this scenario (not pictured), for VM1 114 dummy device insertion, one dummy device would be inserted into a first port in virtual USB host controller 1 (130) for VM2's 116 total required bandwidth (the sum of the required bandwidths of all USB devices attached to VM2 116, or USB device 2 110 required bandwidth in this case) and a second dummy device would also be inserted into a second port in virtual USB host controller 1 (130) for VM3's 118 total required bandwidth (the sum of the required bandwidths of all devices attached to VM3 118, or USB device 3 112 required bandwidth in this case).

In yet other embodiments, one dummy device is inserted for each device not attached to the VM receiving the dummy devices. In this scenario (not pictured), VM1 114 would have two dummy devices inserted into ports in virtual USB host controller 1 (130), one dummy device to represent the required bandwidth of USB device 2 110 and one dummy device to represent the required bandwidth of USB device 3 112.

The dummy device option is well suited to a legacy VM who runs legacy USB drivers that do not comprehend virtualization. On the other hand, if the physical USB host controller drivers (120, 122, and 124 in FIG. 2) do comprehend virtualization, an alternate solution to configure multiple virtual machines to share USB bandwidth is available.

In many embodiments, each instantiated virtual USB host controller (130, 132, and 134 in FIG. 2) may have a MAXIMUM ISOCHRONOUS BANDWIDTH register implemented. In these embodiments, the driver located in each VM comprehends this register that controls the fraction of the frame bandwidth that the driver should be allowed to use. Thus, in some embodiments, MAXIMUM ISOCHRONOUS BANDWIDTH registers 206, 208, and 210 are located in virtual USB host controllers 1, 2, and 3 respectively. In these embodiments, each register can set the maximum fraction of the total per frame USB bandwidth for each VM to ⅓ (three VM's indicate that in the best case scenario each VM can utilize ⅓ of the total bandwidth and this would allow all three VMs equal access to the USB stack.

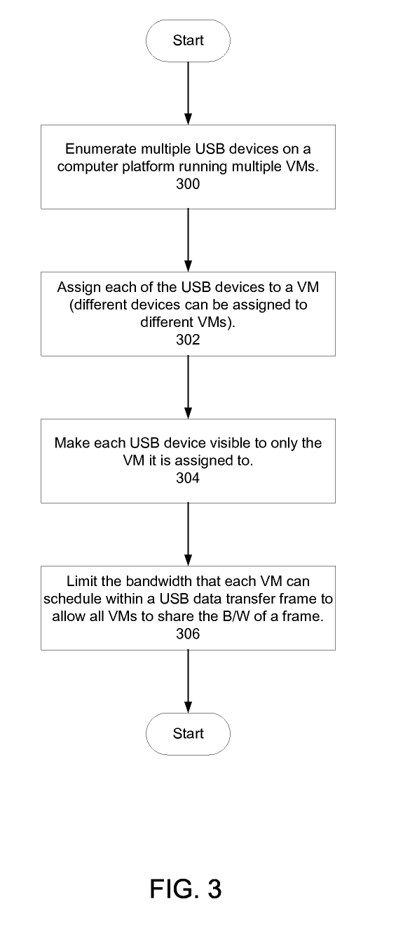

FIG. 3 is a flow diagram of one embodiment of a process to share USB isochronous bandwidth among multiple virtual machines. The process is performed by processing logic that may comprise hardware (circuitry, dedicated logic, etc.), software (such as is run on a general purpose computer platform or a dedicated machine), or a combination of both. Referring to FIG. 3, the process begins by processing logic enumerating more than one USB device on a computer platform running more than one virtual machine (processing block 300). Next, processing logic assigns each of the USB devices to one of the virtual machines (processing block 302). The USB devices can all be assigned separate virtual machines or some of them may be assigned the same virtual machine. Next, processing logic makes each USB device visible only to the virtual machine it was just assigned to (processing block 304). Finally, processing logic limits the bandwidth that each of the virtual machines can schedule on the USB stack at a per frame basis to specifically allow all of the virtual machines in the computer platform to share the bandwidth of a frame (processing block 306). The ways to limit the bandwidth (including assigning dummy devices to each virtual machine or utilizing a MAXIMUM ISOCHRONOUS BANDWIDTH register for each virtual USB host controller) are described in detail above in reference to FIG. 2.

Thus, embodiments of a method and computer readable medium to share USB isochronous bandwidth among multiple virtual machines on a computer platform are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
enumerating a plurality of USB devices on a computer platform running a plurality of virtual machines (VMs);
assigning each of the plurality of USB devices to one of the plurality of VMs, wherein each USB device may be assigned to a different VM;
making each USB device visible only to the one of the plurality of VMs it is assigned to; and
limiting the bandwidth each of the plurality of VMs can schedule, for its assigned USB devices, within a USB data transfer frame to allow all of the plurality of VMs to have access to the bandwidth of the frame.

2. The method of claim 1, further comprising
assigning a virtual USB host controller for each of the plurality of VMs, wherein each of the plurality of VMs is assigned its own virtual USB host controller; and
causing each virtual USB host controller to only reflect USB device information of the USB devices assigned to the VM that the virtual USB host controller is assigned to.

3. The method of claim 2, further comprising:
inserting one or more dummy devices to interact with each VM, each dummy device being only visible to a single VM, wherein each dummy device requests a bandwidth within the frame.

4. The method of claim 3, further comprising:
assigning a dummy device to each of the plurality of VMs, wherein the dummy device for a given VM requests a per frame bandwidth equal to a sum of the bandwidth requested by the one or more USB devices not visible to the given VM.

5. The method of claim 3, further comprising:
assigning one or more dummy devices to each of the plurality of VMs, wherein the number of dummy devices assigned to a given VM is the number of USB devices not visible to the given VM, each dummy device being matched with a different not visible USB device, and wherein each of the one or more dummy devices assigned to the given VM requests a per frame bandwidth equal to the bandwidth requested by the matched not visible USB device.

6. The method of claim 3, further comprising:
assigning one or more dummy devices to each of the plurality of VMs, wherein the number of dummy devices assigned to a given VM is the number of additional VMs in the plurality apart from the given VM, each dummy device being matched with a different of the additional VMs, and wherein each of the one or more dummy devices assigned to the given VM requests a per frame bandwidth equal to the sum of the bandwidth requested by all devices assigned to the matched additional VM.

7. The method of claim 2, storing a value equal to the maximum percentage of bandwidth within a frame each VM assigned to each of the virtual USB host controllers can use in a maximum isochronous bandwidth configuration register located on each of the virtual USB host controllers.

8. A computer readable medium, storing instructions, which when executed by a computer, cause the computer to perform a method, comprising:
enumerating a plurality of USB devices on a computer platform running a plurality of virtual machines (VMs);
assigning each of the plurality of USB devices to one of the plurality of VMs, wherein each USB device may be assigned to a different VM;
making each USB device visible only to the one of the plurality of VMs it is assigned to; and
limiting the bandwidth each of the plurality of VMs can schedule, for its assigned USB devices, within a USB data transfer frame to allow all of the plurality of VMs to have access to the bandwidth of the frame.

9. The computer readable medium of claim 8, further comprising
assigning a virtual USB host controller for each of the plurality of VMs, wherein each of the plurality of VMs is assigned its own virtual USB host controller; and
causing each virtual USB host controller to only reflect USB device information of the USB devices assigned to the VM that the virtual USB host controller is assigned to.

10. The computer readable medium of claim 9, further comprising:
inserting one or more dummy devices to interact with each VM, each dummy device being only visible to a single VM, wherein each dummy device requests a bandwidth within the frame.

11. The computer readable medium of claim 10, further comprising:
assigning a dummy device to each of the plurality of VMs, wherein the dummy device for a given VM requests a per frame bandwidth equal to a sum of the bandwidth requested by the one or more USB devices not visible to the given VM.

12. The computer readable medium of claim 10, further comprising:
assigning one or more dummy devices to each of the plurality of VMs, wherein the number of dummy devices assigned to a given VM is the number of USB devices not visible to the given VM, each dummy device being matched with a different not visible USB device, and wherein each of the one or more dummy devices assigned to the given VM requests a per frame bandwidth equal to the bandwidth requested by the matched not visible USB device.

13. The computer readable medium of claim 10, further comprising:
assigning one or more dummy devices to each of the plurality of VMs, wherein the number of dummy devices assigned to a given VM is the number of additional VMs in the plurality apart from the given VM, each dummy device being matched with a different of the additional VMs, and wherein each of the one or more dummy devices assigned to the given VM requests a per frame bandwidth equal to the sum of the bandwidth requested by all devices assigned to the matched additional VM.

14. The computer readable medium of claim 9, storing a value equal to the maximum percentage of bandwidth within a frame each VM assigned to each of the virtual USB host controllers can use in a maximum isochronous bandwidth configuration register located on each of the virtual USB host controllers.
